(19) United States
(12) Patent Application Publication
(10) Pub. No.: US 2003/0095802 A1
(43) Pub. Date: May 22, 2003

(54) Image formation method

(75) Inventors: Yasunori Mimaki, Kanagawa (JP); Makoto Yamada, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/286,999

(22) Filed: Nov. 4, 2002

(30) Foreign Application Priority Data
Nov. 2, 2001 (JP) P. 2001-338165

(51) Int. Cl. G03D 3/00

(52) U.S. Cl. 396/564

(57) ABSTRACT

In the present invention, an image formation method of recording digital image information on a silver salt color film to obtain an image, comprises:

applying chroma saturation changing processing to the digital image information;

recording the image information to which the processing has been applied, on the silver salt color film by a scan exposure; and

developing the exposed color film with a CD-3-containing developer to obtain the image.

### FIELD OF THE INVENTION

The present invention relates to an image formation method in which digital image information is recorded on a silver salt color film. More particularly, the invention relates to an image formation method in which digital image information is recorded on a silver salt color film by scanning exposure, and general-purpose development processing, that is to say, development applied to a film having a usual non-digital image recorded thereon, is conducted to obtain an image.

### BACKGROUND OF THE INVENTION

With the recent spread of computers, it has come to be widely carried out that images are converted to digital image signals, which are subjected to various processing. For example, in the field of general photography, a system has been spreading in which digital information obtained by scanning a color negative film with a scanner is subjected to color gradation adjustment processing or image structure adjustment processing, and then, outputted onto color paper.

On the other hand, also in a system dealing with moving pictures such as movies, a technique dealing with images converted to digital image information has recently come to be widely used, because of easy special effects and image synthesis. In such a system, the digital image information of images recorded is obtained by converting the images on a movie color negative film to the digital image information with a scanner, or directly photographing a subject with a digital video camera. After a special effect has been added, the image information is outputted imagewise to an intermediate film by use of a laser recording apparatus. This is developed to form a negative, which is printed to a positive film, and finally used for projection.

Now, in a developer (a developing solution) for a color negative film used in general still photographing, 4-amino-3-methyl-N-ethyl-N-(β-hydroxyethyl)aniline sulfate (hereinafter referred to as CD-4) is used as a developing agent. In contrast, in the development of a movie color negative film intended for motion picture photographing, 4-amino-3-methyl-N-(β-methanesulfoamidoethyl)aniline sesquisulfate monohydrate (hereinafter referred to as CD-3) is used as a developing agent. Although CD-3 and CD-4 are both trade names of Eastman Kodak Co., developing agents having the same chemical formulas supplied from other manufacturers are also customarily called CD-3 and CD-4 in this industry, and CD-3 and CD-4 have become general names. Accordingly, this specification also follows this customary usage. The difference in performance as a color developing agent between both agents is mainly the difference in developing activity, and a developing solution containing CD-3 is known to be lower in developing activity, resulting in softer gradation of an image developed. Usually, for the movie color negative film, the gradation throughout the total system is designed, based on the assumption that the movie color negative film is processed with this CD-3-containing developing solution. Accordingly, it does not occur that a final positive image appears to be soft in gradation.

However, when intended for the digital image information, the situation is different. That is to say, recording of the digital image information on a light-sensitive material is made with a digital recording apparatus, and an image is mainly recorded by scanning of a beam spot of a laser beam. In other words, a film is irradiated with image-modulated beam light. According to this irradiated light, exposure is necessarily conducted at a higher illumination for a shorter time than usual plane exposure, so long as it is a laser beam. In general, the light-sensitive characteristics of a silver salt light-sensitive material is know to contain the phenomenon of reciprocity failure, which causes gradation characteristics to change when exposure is conducted at a higher illumination for a shorter time than usual exposure, thus showing softer-gradation characteristics.

In contrast with CD-4 processing used in the general color negative film, CD-3 processing used in the movie color negative film is liable to be influenced by reciprocity failure. Accordingly, when a silver salt color film is subjected to laser exposure, and developed with the CD-3-Containing developing solution, the gradation is softened beyond expectation. As a result, the problem that an image finally obtained is not concise and has insufficient chroma saturation has been encountered. Moreover, this softening of gradation is known to correlate with the size of silver halide particles, and the smaller particle size has the greater influence caused by reciprocity failure. In addition to that, in the above-mentioned digital image processing system of the movie film, the digital image information is digitally recorded on the intermediate film. However, the intermediate film is essentially a light-sensitive material for preparing a dupe of an original, and chroma saturation changing means such as interlayer effect is not incorporated in a light-sensitive material designing step, so that the above-mentioned defects appear more significantly.

### SUMMARY OF THE INVENITON

The invention is made for solving the above-mentioned problems associated with the image formation method of obtaining digital image information from an original image and recording it on a silver salt color film, as image duplicating means. Specifically, an object of the invention is to provide image formation method which does not impair the conciseness of an image and does not reduce chroma saturation, even when digital image information is carried on beam light, a silver salt color film is subject to a scan exposure by the beam light, and this film is developed with a CD-3-containing developing solution.

The present inventors have intensively studied various methods for compensating the softening of gradation caused by high illumination intensity reciprocity failure occurring in recording digital image information, and a reduction in chroma saturation accompanying it. As a result, it has been discovered that the above-mentioned compensation is possible, when image processing for changing chroma saturation is applied to digital image information. It is unexpected that the chroma saturation changing processing for usually improving a reduction in chroma saturation or color reproduction caused by photographing or development can compensate the softening of gradation and a reduction in chroma saturation derived from a completely different cause and mechanism, the high illumination intensity failure associated with scan exposure. Based on this discovery, further studies have been conducted, thus resulting in completion of the invention.

According to the invention, there are provided:

1. An image formation method of recording digital image information on a silver salt color film to obtain an image,

the image formation method comprising:

applying chroma saturation changing processing to the digital image information;

recording the image information to which the processing has been applied, on the silver salt color film by a scan exposure; and

developing the exposed color film with a CD-3-containing developer to obtain the image.

2. The image formation method according to the item 1, wherein the chroma saturation changing processing includes at least one processing of matrix processing, SCC processing and 3DLUT changing processing.

3. The image formation method according to the item 1, wherein the chroma saturation changing processing is combined processing of matrix processing and SCC processing.

4. The image formation method according to the item 1, wherein the chroma saturation changing processing is combined processing of matrix processing, SCC processing and 3DLUT changing processing.

5. The image formation method according to the item 1, wherein the silver salt color film includes a red-sensitive layer, a green-sensitive layer and a blue-sensitive layer, and a mode value of a particle size distribution of silver halide particles in a highest sensitivity unit layer of at least one of a red-sensitive layer, a green-sensitive layer and a blue-sensitive layer is 0.3 μm or less, and the silver halide particles include a silver halide containing 50 mol % or more of AgBr.

6. The image formation method according to the item 1, wherein the silver salt color film includes a tubular silver halide particle in an amount of 50 wt % or more, based on total weight of silver halide particles.

7. The image formation method according to the item 1, wherein the back surface of the silver salt color film before development processing has the conductivity of 1.0×10¹¹ Ω/square or less as a surface resistance value.

8. The image formation method according to the item 1, wherein the digital image information is obtained by scanning a movie color negative film developed.

9. The image formation method according to the item 1, wherein the digital image information is obtained with a digital video camera.

10. The image formation method according to the item 1, wherein the exposure intensity of the scan exposure is variable, and the exposure time is 10⁻⁴ second per pixel or less.

For the chroma saturation changing processing, also when the following image processing or combined processing of the image processing is applied, in addition to the above-mentioned processing, the effect intended in the invention can be obtained:

a. Matrix processing

3×3 matrix processing

3×9 matrix processing

b. SCC processing

c. 3DLUT changing processing (also referred to as three-dimensional LUT or three-dimensional LUT changing processing)

d. Combined processing of matrix processing and 3DLUT changing processing

e. Combined processing of SCC processing and 3DLUT changing processing

Further, in the above, the case that the above-mentioned digital image information is image information prepared by computer graphics and outputted is also included in the image formation method of the invention.

### BRIEF DESCRIPTION OF THE DRAWINGS

FIG. 1 is a block diagram showing a flow of image processing in one embodiment of the invention; and

FIG. 2 is an explanatory diagram showing test processes of an example and comparative examples.

### DETAILED DESCRIPTION OF THE INVENTION

The image formation method of the invention is intended for the preparation of a duplicate of an original image, and the image formation process comprises (1) preparing digital image information for input to be applied to the image formation method of the invention, (2) subjecting the image information to chroma saturation changing image processing, (3) carrying the image-processed image information on laser light, performing a scan exposure of a color film by the laser light, and (4) developing the exposed color film with a general-purpose color developing solution. That is to say, the image formation process comprises the following procedures.

(1) The Preparation of Digital Image Information for Input to be Applied to the Image Formation Method of the Invention

The digital image information is prepared by scanning a color film with a scanner, utilizing image information photographed with a digital video camera and outputted, using CG (computer graphic) image information produced on a computer, or producing image information in which a special technique effect is further superimposed on image information from a color negative. In addition, any image information can be used as long as it is image information converted to electrical signals according to a scan protocol.

(2) Chroma Saturation Changing Image Processing of Digital Image Information

The chroma saturation changing image processing applied to the digital image information is an image conversion operation of making image conversion correction in image information inputted. As the image conversion operation, suitable is 3×3 matrix calculation, 3×9 matrix calculation, SCC processing, three-dimensional LUT changing processing or arbitrarily combined calculation processing thereof.

(3) Scan Exposure With Image Information-Carrying Beam Light

The image-processed digital image information is carried on beam spot light such as laser light with a digital image output apparatus, and a silver salt color film is scan exposed thereto.

The silver salt color film used in the invention is preferably a film containing fine particles in which the mode value of size distribution of particles contained in a highest sensitivity unit layer of at least one layer of a red-sensitive layer, a green-sensitive layer and a blue-sensitive layer is 0.3 μm or less, and the silver halide particles of the unit layer are silver iodobromide particles having a Br content of 50 mol % or more. More preferably, the silver salt color film is a film containing fine particles in which the mode value of size distribution of particles contained in each highest sensitivity unit layer of a red-sensitive layer, a green-sensitive layer and a blue-sensitive layer is 0.3 μm or less, and more preferably, the silver halide particles of the film are silver iodobromide particles having a Br content of 50mol % or more. In another preferred embodiment, 50% by weight of the whole particles of the film are tabular particles.

The invention is especially suitable for preparing a dupe of an original film. Accordingly, the above-mentioned image formation is carried out using an intermediate film as a film for duplication.

In a conventional dupe preparation method, a dupe negative is obtained by repeating twice contact print to an internegative film. In contrast, when the image formation is carried out by scan exposure using digital information, a dupe negative is obtained by single print exposure and development. This is also a further advantage.

When the color image formation method is utilized in the duplication of a movie film, it is necessary that the back face conductivity before development processing of the silver salt color film such as the intermediate film is sufficient in order to ensure the handling suitability of a long film, particularly the feeding properties of an image-processed film in exposure to laser spot light. The surface resistance value is desirably 1.0×10¹¹ Ω/square or less.

(4) Development Processing of the Exposed Color Film

Then, the exposed color film is developed with a general-purpose color developing solution. The invention is suitable for preparation of the dupe of the movie original film as described above, so that development processing using the CD-3-containing developing solution as the developing solution, particularly, ECN2 processing is preferably used. Although the ECN2 processing is the name of processing designed by Eastman Kodak Co., it is generally used as internationally common processing.

The digital image processing applied to the invention will be described in more detail. In the invention, the chroma saturation changing processing allowing chroma saturation to change is applied to color image data indicating a color image. In the chroma saturation changing processing, digital image information obtained from a general color image such as a color photograph or a computer graphic image with an image processing apparatus having a calculation program for improving chroma saturation is used as input image information, and calculation is executed to this input image information to convert it to an image signal elevated in chroma saturation, which is outputted as a data value (density) of an image finally obtained. It is simple and easy to conduct conversion processing from this input digital image information to output digital image information by matrix calculation. The constitution of the matrix is executed by the scheme of converting density data of each color in the color image information to exposure density data based on a characteristic curves indicating the relationship between density and exposure density, applying the above-mentioned specified image processing to the exposure density data to obtain processed exposure density data, and converting the processed exposure density data to processed density data based on the above-mentioned characteristic curve to obtain processed color image data.

The term “characteristic curves indicating the relationship between density and exposure density” means, specifically, for example, a characteristic curve indicating the relationship between exposure density in a photographic material and the amount of a color-developed dye generated according to the degree of exposure. Actually, as a conversion parameter, a characteristic curve indicating the relationship between exposure density and density in a characteristic curve of a color negative film such as an intermediate film is used as a general rule. The empirical correction coefficient may be further added to each parameter value. Details thereof are described in “Color Photographic Optics” generally edited by Hideo Kusaka (Ohm Co., Publishing Department).

Furthermore, the color image data is obtained by not only the photographic material, but also by photographing a subject image with a digital still camera. The characteristic curve in this case is determined in the following manner. First, a gray step wedge is photographed with the digital still camera under a standard light source. In this case, the visual density of each patch in the wedge is taken as Dvi (i=1, 2, 3, . . . n). At the same time, a standard white plate is photographed, and the visual density thereof is taken as Dvs. Then, the difference in visual density between the standard white plate and each patch is taken as exposure density EDi (i=1, 2, 3, . . . n), which is taken as the abscissa of the characteristic curve. After that, the output signal value (Ri, Gi, Bi) (i=1, 2, 3, . . . n) to each gray step wedge of the digital still camera is determined, and this is taken as the ordinate of the characteristic curve. There is no guarantee that the signal value of the digital still camera in this case is logarithmic in dimension. However, there is no particular problem. The correspondence relationship of the signal value thus determined is determined, and this is used in the same position as the characteristic curve used in the base of the conversion parameter of the above-mentioned color film.

Various calculation methods based on the above-mentioned calculation concept have been known. However, as the chroma saturation changing processing applied to the image processing in the invention, there are preferably used matrix processing, SCC processing, processing called 3DLUT conversion processing and appropriately combined processing thereof. Preferred calculation processing programs are as shown below:

a. Matrix processing

3×3 matrix processing

3×9 matrix processing

b. SCC processing

c. 3DLUT conversion processing

d. Combined processing of matrix processing and 3DLUT conversion processing

e. Combined processing of SCC processing and 3DLUT conversion processing

f. Combined processing of matrix processing and SCC conversion processing

g. Combined processing of matrix processing, SCC processing and 3DLUT conversion processing

Of these, combined processing of matrix processing and SCC conversion processing and combined processing of matrix processing, SCC processing and 3DLUT conversion processing are particularly preferred for attaining the effect intended in the invention.

Matrix Processing

The matrix processing is processing in which calculation for converting image information inputted in the form of R, G and B signals to output image information Ro, Go and Bo (exposure density data after calculation processing) in the form of R, G and B signals corresponding to exposure density data Ri, Gi and Bi (before calculation processing) is made. Of the matrix processing, the simplest and practical processing is the 3×3 matrix processing, and preferably conducted based on the following equation (1):

$$( \begin{matrix}Ro \\ Go \\ Bo\end{matrix} ) = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34}\end{matrix} ) ( \begin{matrix}Ri \\ Gi \\ Bi \\ 1\end{matrix} ) \qquad ( 1 )$$

Ri, Gi, Bi: Exposure density data

Ro, Go, Bo: Processed exposure density data

In the case of a₁₄=a₂₄=a₃₄=0, equation (1) shows a complete 3×3 matrix. However, in the invention, it is preferred in some cases that a parameter is employed in which a₁₄, a₂₄ and a₃₄ are other than 0 as a correction coefficient based on the experience of movie film preparation and the characteristics of a printer, a processor or the like. Such a case is also included in the 3×3 matrix.

Further, the 3×9 matrix processing is conducted based on the following equation (2):

$$( \begin{matrix}Ro \\ Go \\ Bo\end{matrix} ) = ( \begin{matrix}{a}_{11} & {a}_{12} & {a}_{13} & {a}_{14} & {a}_{15} & {a}_{16} & {a}_{17} & {a}_{18} & {a}_{19} & {a}_{1 a} \\ {a}_{21} & {a}_{22} & {a}_{23} & {a}_{24} & {a}_{25} & {a}_{26} & {a}_{27} & {a}_{28} & {a}_{29} & {a}_{2 a} \\ {a}_{31} & {a}_{32} & {a}_{33} & {a}_{34} & {a}_{35} & {a}_{36} & {a}_{37} & {a}_{38} & {a}_{39} & {a}_{3 a}\end{matrix} ) ( \begin{matrix}Ri \\ Gi \\ Bi \\ {Ri}^{2} \\ {Gi}^{2} \\ {Bi}^{2} \\ Ri Gi \\ Gi Bi \\ Bi Ri \\ 1\end{matrix} ) \qquad ( 2 )$$

Ri, Gi, Bi: Exposure density data

Ro, Go, Bo: Processed exposure density data

Ri, Gi, Bi, Ro, Go and Bo have the same meanings as described above. In the case of a₁ₐ=a₂ₐ=a₃ₐ=0, equation (2) shows a complete 3×9 matrix. However, in the invention, it is preferred in some cases that a parameter is employed in which a₁ₐ, a₂ₐ and a₃ₐ are other than 0 as a correction coefficient based on the experience of movie film preparation and the characteristics of a printer, a processor or the like. Such a case is also included in the 3×9 matrix.

SCC (Selective Color Correction) Processing

This processing is a technique of dividing a color space into 6 hues (R, Y, G, C, B and M), and independently adding color correction to each of the hues. The SCC processing is indicated by the following equation:

f_{R}=max{R−max(G,B),0}

f_{Y}=max{min(R,G)−B,0}

f_{G}=max{G−max(B,R),0}

f_{C}=max{min(G,B)−R,0}

f_{B}=max{B−max(R,G),0}

f_{M}=max{min(B,R)−G,0} (3)

wherein R, G and B are image signals (image density data) of three colors before calculation processing, and R′, G′ and B′ are image signals (image density data) of three colors after calculation processing. K_{RR}, K_{YR}, K_{GR}, K_{CR}, K_{BR}, K_{MR}, K_{RG}, K_{YG}, K_{GG}, K_{CG}, K_{BG}, K_{MG}, K_{RB}, K_{YB}, K_{GB}, K_{CB}, K_{BB} and K_{MB} each represents a color adjusting parameter for each hue, and a user sets a value of this parameter depending on the purpose and uses it. f_{R}, f_{Y}, f_{G}, f_{C}, f_{B} and f_{M} are each a coefficient indicating what hue an input color signal belongs to, and represented by the following formulas:

R′=R+K_{RR}·f_{R}+K_{YR}·f_{Y}+K_{GR}·f_{G}+K_{CR}·f_{C}+K_{BR}·f_{B}+K_{MR}·f_{M}

G′=G+K_{RG}·f_{R}+K_{YG}·f_{Y}+K_{GG}·f_{G}+K_{CG}·f_{C}+K_{BG}·f_{B}+K_{MG}·f_{M}

B′=B+K_{RB}·f_{R}+K_{YB}·f_{Y}+K_{GB}·f_{G}+K_{CB}·f_{C}+K_{BB}·f_{B}+K_{MB}·f_{M} (4)

Here, max(a, b) represents a larger one of a and b, and min (a, b) represents a smaller one of a and b.

Three-Dimensional LUT (Look Up Table) Conversion

The three-dimensional LUT (look up table) conversion is a technique of conducting signal conversion using a corresponding table (lookup table) in which output signal values to respective combinations of input signals (image density data before processing) are described. The output values to the input signals are directly describe, so that this is also applicable to conversion difficult to be formulated. The color signal is generally indicated by three components. In the case of color signal conversion, therefore, the form of three-signal input and three-signal output is taken, and called the three-dimensional LUT. In the case of the three-dimensional LUT conversion, the storage of output values to all combinations of input signals necessitates a memory having a tremendously large capacity. It is therefore general to use a technique of storing the three-dimensional LUT to input signals at proper intervals, and determining a corresponding output value by interpolation processing when an intermediate value is encountered. As typical techniques for interpolation processing, there are known cubic interpolation, tetrahedral interpolation and prism interpolation (reference: Gazo Denshi Gakkai-shi, 22 (4), 382-393 (1993)).

When the three-dimensional look up table is applied to the invention to convert the image information, there are provided exposure density conversion means for converting scan read density information of each color of inputted digital color image information to exposure density data, based on a characteristic curve showing the relationship between density and exposure density, image processing means for applying the above-mentioned specified image processing to the exposure density data to obtain processed exposure density data, and exposure density inverse conversion means for converting the processed exposure density data to processed density data based on the above-mentioned characteristic curve to obtain processed color image data to be outputted to a color film to be printed.

Furthermore, the characteristic curve in the image processing according to the invention is based on a characteristic curve indicating the relationship between exposure density having the same spectral distribution as illumination light at the time when an image indicated by color image data is obtained and photographic density.

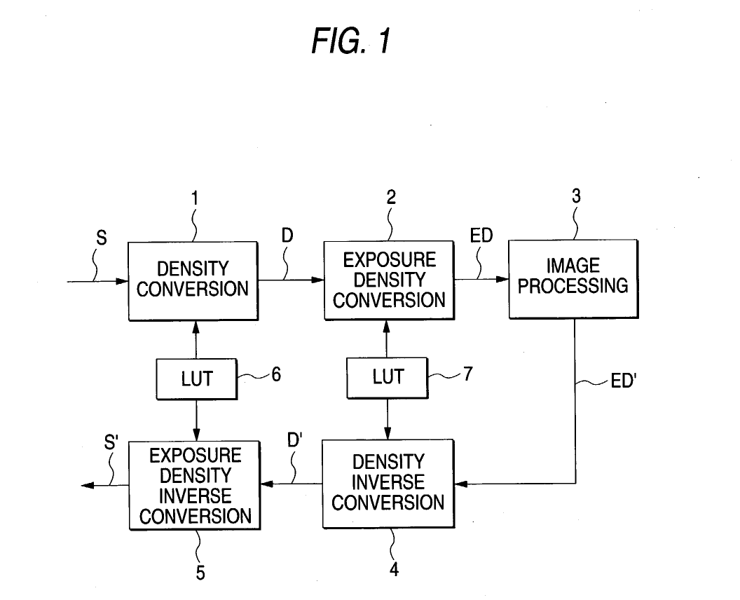

FIG. 1 shows a specific embodiment of the three-dimensional LUT conversion. FIG. 1 is a block diagram showing a flow of image processing preferably used in an embodiment of the invention, in which color changing processing is incorporated. As shown in FIG. 1, it comprises density conversion means 1 for converting image data S indicating a color image to density data D of each of R, G and B in reference to an LUT 6, exposure density conversion means 2 for converting density data D to exposure density data ED in reference to an LUT 7, image processing means 3 for applying image processing containing color changing processing to the exposure density data ED to obtain processed exposure density data ED′, exposure density inverse conversion means 4 for converting the processed exposure density data ED′ to processed density data D′ in reference to the LUT 7, and density inverse conversion means 5 for converting the processed density data D′ to processed image data S′ in reference to the LUT 6.

The preferred embodiment of the invention in which the image processing such as the color changing processing is conducted on the level of exposure density converted from density is described above. However, the image processing can also be conducted for image data on the level of density.

In this embodiment, the density data D and the exposure density data ED each consists of three data of R, G and B, but indicates one of the data for simplicity.

The LUT 6 is a one-dimensional look up table for converting the image data S to the density data D. Specifically, it is obtained by reading a gray step wedge with a scanner, measuring the RGB density of the gray step wedge with a densitometer, and allowing a read value of the scanner and a measurement with the densito meter to correspond to each other. Then, the density conversion means 1 converts the image data S to the density data D in reference to the LUT 6, and the density inverse conversion means 5 converts the processed density data D′ to the processed image data S′ in reference to the LUT 6.

The LUT 7 is a one-dimensional lookup table for converting density to exposure density, corresponding to a characteristic curve of a photographic material at the time when the above-mentioned color image is photographed in the photographic process. Further, when the image data S is obtained with a digital still camera, there is used a characteristic curve indicating the relationship between exposure density having the same spectral distribution as illumination light at the time when the image data S is obtained and density. Then, the exposure density conversion means 2 converts the density data D to the exposure density data ED in reference to the LUT 7, and the exposure density inverse conversion means 4 converts the processed exposure density data ED′ to the processed density data D′ in reference to the LUT 7.

The image processing means 3 conducts color changing processing for improving chroma saturation to the exposure density data ED obtained in the exposure density conversion means 2 by matrix calculation, thereby applying image processing.

First, an image photographed on a color film, for example, a Type 8552 film manufactured by Fuji Photo Film Co., Ltd. is read together with a gray step wedge with a scanner (IMAGICA IMAGER, manufactured by Imagica). Then, the RGB density of the above-mentioned gray step wedge is measured with a Xrite densitometer (manufactured by Xrite, having a density measurement optical system specified in ISO 5), and the one-directional look up table (LUT 6) allowing readings of the above-mentioned scanner and density values measured with the densitometer to correspond to each other is prepared. On the other hand, the above-mentioned film to which gray sensitometry exposure is given so as to reproduce the maximum density and minimum density of the photographic material is measured with the Xrite densitometer, and the one-directional look up table (LUT 7) allowing exposed density and density to correspond to each other is prepared. Then, the image information is converted to the RGB density data by the LUT 6, and the density data is converted to the exposure density data by the LUT 7. Then, color conversion matrix calculation of gray storage is executed to the exposure density data according to the following equation (3). The resulting exposure density data is passed through the LUT 7 in the reverse direction, and converted to the density data again. The density data is converted to a scanner signal again by use of the LUT 6, and the signal finally obtained is sent to a laser recording apparatus.

As an image processing apparatus, there can be used a commercial apparatus in which the above-mentioned respective image data conversion calculation programs are incorporated alone or in combination. In such an apparatus, it is possible to use a program described in the c language, which can be executed on a general workstation. The clock frequency of a CPU of the above-mentioned workstation is preferably 200 MHz or more.

Then, the development processing will be described. In the color image formation method of the invention, any known development processing methods using CD-3can be used. However, preferred is movie color negative development processing. Especially, ECN2 processing designed by Eastman Kodak Co. is preferred. However, the processing is not limited thereto.

CD-3, the color developing agent, originally means 4-amino-3-methyl-N-etyl-N-(β-methanesulfoamidoethyl)-aniline sesquisulfate monohydrate as a trade name. However, CD-3 used in this specification includes modified salt forms of 4-amino-3-methyl-N-etyl-N-(β-methanesulfoamidoethyl)-aniline, such as the p-toluenesulfonate, sulfate, phosphate, hydrochloride, sulfite and naphthalenedisulfonate thereof. They may be further hydrated.

The aromatic primary amine developing agent is added to the developing solution so that the concentration of the developing agent in the solution used is from 2 mmol to 200 mmol, preferably from 6 mmol to 100 mmol, and more preferably from 10 mmol to 40 mmol, per liter of developing solution.

Sulfite ions are preferably contained in the color developing solution in small amounts. Further, a small amount of hydroxylamine may also be contained. When hydroxylamine (although it is generally used in the form of the hydrochloride or the sulfate, the form of the salt is hereinafter omitted) is contained, it acts as a preservative similarly to the sulfite ions. However, it is necessary to keep the amount thereof added in reduced amounts.

The color developing solution may contain an organic preservative as the preservative, as well as the above-mentioned hydroxylamine and sulfite ions. The organic preservative means a general organic compound which reduces the rate of degradation of the aromatic primary amine color developing agent. That is to say, it is an organic compound having the function of preventing air oxidation of the color developing agent. Above all, particularly effective organic preservatives are hydroxamic acids, hydrazides, phenols, α-hydroxyketones, α-aminoketones, saccharides, monoamines, diamines, polyamines, quaternary ammonium salts, nitroxy radicals, alcohols, oximes, diamide compounds and cyclocondensation type amines, including the above-mentioned hydroxylamine derivatives.

As other preservatives, various kinds of metals described in Japanese Patent Laid-Open Nos. 44148/1982 and 53749/1982, salicylic acid derivatives described in Japanese Patent Laid-Open No. 180588/1984, alkanolamines described in Japanese Patent Laid-Open No. 3532/1979, polyethyleneimines described in Japanese Patent Laid-Open No. 94349/1981 and aromatic polyhydroxy compounds described in U.S. Pat. No. 3,746,544 may be contained as needed. In particular, for example, alkanolamines such as triethanolamine and triisoprpanolamine, substituted or unsubstituted dialkylhydroxylamines such as disulfoethylhydroxylamine and diethylhydroxylamine, or aromatic polyhydroxy compounds may be added.

Although the content of the preservative in the developing solution varies depending on the kind of preservative, the preservative is generally added to the solution used so as to give a concentration of 1 mmol to 200 mmol, preferably 10 mmol to 100 mmol, per liter of developing solution.

Bromine ions are contained in the color developing solution, and the concentration thereof is preferably from about 1 to about 5×10⁻³ mol/liter. Although the bromine ions are unnecessary for a color developing replenisher in many cases, they are added as needed so as to give a bromine ion concentration within the above-mentioned range in some cases.

The mainly intended color film in the invention usually mainly comprises a silver iodobromide emulsion, so that iodine ions are released from the photographic material to yield an iodine ion concentration of about 0.5 to about 10 mg per liter of developing solution. Accordingly, no iodine ions are normally contained in a replenisher.

Bromine ion-feeding materials include sodium bromide, potassium bromide, ammonium bromide, lithium bromide, calcium bromide, magnesium bromide, manganese bromide, nickel bromide, cerium bromide and thallium bromide. Of these, preferably used are potassium bromide and sodium bromide.

As iodine ion-feeding materials, there are used sodium iodide and potassium iodide.

In the invention, the pH of the developing solution is preferably from 9.0 to 13.5, and the pH of the replenisher is preferably from 9.0 to 13.5. Accordingly, an alkali agent and a buffer, with an acid agent as needed, can be added to the developing solution and the replenisher so that their pH values can be maintained.

As the alkalis, various kinds of hydroxides can be added. Examples thereof include potassium hydroxide, sodium hydroxide, lithium hydroxide, tripotassium hydrogenphosphate, trisodium hydrogenphosphate and a hydrate thereof. Further, as the acid agents added as needed, there can be used inorganic and organic water-soluble solid acids. Examples thereof include succinic acid, tartaric acid, propionic acid and ascorbic acid.

In order to maintain the above-mentioned pH at the time when the processing solution is prepared, various kinds of buffers are preferably used. In particular, carbonates, phosphates, tetraborates and hydroxybenzoates have the advantages that they are excellent in buffering ability in the high pH region of 9.0 or more, that they have no adverse effect (such as fogging) on photographic properties even when added to the color developing solution, and that they are low in cost. The use of these buffers is particularly preferred.

Examples of these buffers include sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (borax), potassium tetraborate, sodium o-hydroxybenzoate (sodium salicylate), potassium o-hydroxybenzoate, sodium 5-sulfo-2-hydroxybenzoate (sodium 5-sulfosalicylate) and potassium 5-sulfo-2-hydroxybenzoate (potassium 5-sulfosalicylate). The buffer is not a component consumed by reaction, so that the concentration thereof is from 0.01 to 2 mol, and preferably from 0.1 to 0.5 mol, per liter, for both the developing solution and the replenisher.

Various kinds of chelating agents, which are suspending agents for other color developing solution components, for example, calcium and magnesium, or which are also stability improvers for the color developing solution, can also be added to the color developing solution. Examples thereof include nitrilotriacetic acid, diethylenetriaminepentaacetic acid, ethylenediaminetetraacetic acid and N,N,N-trimethylene-phosphonic acid.

The amount of these chelating agents may be any, as long as it is sufficient to block metal ions contained in the color developing solution prepared. For example, they are added in an amount of about 0.1 g to about 10 g per liter.

Any development accelerator can be added to the color developing solution as needed. The development accelerators which can be added as needed include thioether compounds, quaternary ammonium salts, amine compounds, polyalkylene oxides, 1-phenyl-3-pyrazolidone compounds and imidazole compounds. The amount thereof added to a composition is determined so as to give a concentration of 0.001 to 0.2 mol, preferably 0.01 to 0.05 mol, per liter, for both the developing solution and replenisher prepared from the processing agent.

In addition to the above-mentioned halogen ions, any antifoggant can be added to the color developing solution used in the invention, as needed. For example, anitrogen-containing heterocyclic compound such as benzotriazole, 5-nitroisoindazole, 5-methylbenzotriazole, indazole, hydroxyazaindolizine or adenine is used. The concentration thereof is from 0.001 to 5.0 mmol, and preferably from 0.01 to 2.0 mmol, per liter, for both the developing solution and the replenisher.

Further, various kinds of surfactants such as an alkylsulfonic acid, an arylsulfonic acid, an aliphatic carboxylic acid and an aromatic carboxylic acid can also be added. The concentration thereof is from 0.0001 to 0.2 mol, and preferably from 0.001 mol to 0.05 mol, per liter, for both the developing solution and the replenisher.

As a bleaching agent used in a bleaching solution or a bleaching-fixing solution, a known bleaching agent can also be used. However, an organic complex salt of iron (III) (for example, a complex salt of an aminopolycarboxylic acid), an organic acid such as citric acid, tartaric acid or malic acid, a persulfate and hydrogen peroxide are particularly preferred.

Of these, the organic complex salt of iron (III) is particularly preferred from the viewpoints of rapid processing and the prevention of environmental pollution. The amino-polycarboxylic acids and salts thereof useful for forming the organic complex salts of iron (III) include ethylene-diaminetetraacetic acid, diethylenetriaminepentaacetic acid, 1,3-diaminopropanetetraacetic acid, propylenediaminetetra-acetic acid, nitrilotriacetic acid, cyclohexanediaminetetra-acetic acid, iminodiacetic acid and glycoletherdiaminetetra-acetic acid, as well as biodegradable ethylenediamine-disuccinic acid (SS form), N-(2-carboxylatoethyl)-L-aspartic acid, β-alaninediacetic acid and methyliminodiacetic acid. These compounds may be any of sodium salts, potassium salts, lithium salts and ammonium salts.

The bleaching agent is added so that the concentration thereof in the processing solution comes to 0.01 to 1.0 mol/liter, preferably 0.03to0.80 mol/liter, more preferably 0.05 to 0.70 mol/liter, and still more preferably 0.07 to 0.50 mol/liter.

It is preferred that the bleaching agent, the bleaching-fixing agent or the fixing agent contains various known organic acids (for example, glycolic acid, succinic acid, maleic acid, malonic acid, citric acid and sulfo succinic acid), organic bases (for example, imidazole and dimethylimidazole), compounds represented by general formula (A-a) described in Japanese Patent Laid-Open No. 211819/1997, including 2-picolinic acid, or compounds represented by general formula (B-b) described in Japanese Patent Laid-Open No. 211819/1997, including kojic acid. The amount of the compound added is preferably from 0.005 to 3.0 mol, and more preferably from 0.05 to 1.5 mol, per liter of processing solution.

A fixing agent used in the bleaching-fixing agent or the fixing agent is a known fixing chemical. That is to say, the fixing chemicals are thiosulfates such as sodium thiosulfate and ammonium thiosulfate, thiocyanates such as sodium thiocyanate and ammonium thiocyanate, thioehter compounds such as ethylenebisthioglycolic acid and 3,6-dithia-1,8-octanediol, and water-soluble agents for dissolving silver halides such as thiourea and derivatives thereof. They can be used either alone or as a mixture of two or more of them. In the invention, the use of thiosulfates, particularly the use of ammonium thiosulfate, is preferred. The concentration of the fixing chemical in the fixing solution and the bleaching-fixing solution is preferably from 0.3 to 3 mol, and more preferably from 0.5 to 2.0 mol, per liter.

The pH region of the bleaching-fixing solution and the fixing solution is preferably from 3 to 8, and particularly preferably from 4 to 8. The pH region of the bleaching solution is 8 or less, preferably from 2 to 7, and particularly preferably from 2 to 6. When the pH is lower than this region, deterioration of the solution and the conversion of a cyan dye into a leuco form are enhanced. Conversely, when the pH is higher than this region, desilverization is retarded, and stains become liable to develop.

It is preferred that the bleaching-fixing solution and the fixing solution each contains as a preservative a sulfite ion-releasing compound such as a sulfite (for example, sodium sulfite, potassium sulfite or ammonium sulfite), a bisulfite (for example, ammonium bisulfite, sodium bisulfite or potassium bisulfite) or a metabisulfite (for example, potassium metabisulfite, sodium metabisulfite or ammonium metabisulfite), or an arylsulfinic acid such as p-toulenesulfinic acid or m-carboxybenzenesulfinic acid. These compounds are preferably contained at a concentration of about 0.02 to about 1.0 mol/liter in terms of sulfite ions or sulfinic acid ions.

After the completion of fixing or bleaching-fixing, washing is carried out. Alternatively, a stabilizing bath substituting for washing or a stabilizing bath for image stabilization can also be used. In these baths, there can also be used isothiazolone compounds or thiabendazoles described in Japanese Patent Laid-Open No. 8542/1982, chlorine disinfectants such as chlorinated sodium isocyanurate described in Japanese Patent Laid-Open No. 120145/1986, benzotriazole described in Japanese Patent Laid-Open No. 267761/1986, a copper ion, and besides, disinfectants described in Hiroshi Horiguchi, “Bohkin Bohbaizai no Kagaku” (Chemistry of Disinfectants and Fungicides), Sankyo Shuppan (1986), “Biseibutsu no Mekkin, Sakkin, Bohbai Gijutsu” (Sterilization, Pasteurization and Fungus Prevention Techniques of Microorganisms), edited by Eisei Gijutsukai, Kogyo Gijutsukai (1982) and “Bokin Bohbaizai Jiten” (Dictionary of Disinfectants and Fungicides), edited by Nippon Bohkin Bohbai Gakkai (1986), when required.

Further, aldehydes such as formaldehyde, acetaldehyde and pyruvic aldehyde for inactivate remaining magenta couplers to prevent the fading of dyes and the formation of stains, methylol compounds or hexamethylenetetramine described in U.S. Pat. No. 4,786,583, hexahydrotriazines described in Japanese Patent Laid-Open No. 153348/1990, formaldehyde-bisulfite adducts described in U.S. Pat. No. 4,921,779 and azolylmethylamines described in EP-A-504609 and EP-A-519190 may be added. Furthermore, surfactants can also be used as wetting agents, and chelating agents represented by EDTA as water softeners.

Then, processing stages used in the method of the invention will be described.

In the case of the color photographic material, the development processing comprises a color developing stage, a desilverization stage, a washing or stabilizing stage and a drying stage, and a supplemental stage such as a rinsing stage, an intermediate washing stage or a neutralization stage can also be inserted between the respective stages. The desilverization stage is performed by one-step processing using a bleaching-fixing solution, or two-step processing comprising a bleaching stage and a fixing stage. Further, in addition to the stabilizing bath substituting for washing, which is substituted for the washing stage, an image stabilizing bath intended for image stabilization can also be provided between the washing or stabilizing stage and the drying stage.

The processing method used in the invention may be any of rapid development type, low replenishment type and internationally interchangeable standard type processing methods.

The processing temperature of the development processing is generally from 30° C. to 40° C. In rapid processing, however, it is from 38° C. to 65° C., and preferably from 40° C. to 55° C. The development processing time is from 1 minute to 8 minutes in general processing. The replenishment rate is from 600 to 1000 ml per m² of photographic material in standard development.

In the color development processing, the development stage is followed by the desilverization stage, and the photographic material is processed with the bleaching solution and the bleaching solution, or the bleaching-fixing solution.

The bleaching time is usually from 10 seconds to 6 minutes and 30 seconds, preferably from 10 seconds to 4 minutes and 30 seconds, and particularly preferably from 15 seconds to 3 minutes.

The color photographic material is generally subjected to washing or stabilizing bath processing after desilverization processing.

The amount of washing water in the washing stage can be widely established depending on the characteristics of the photographic material (for example, a material used such as a coupler), the use, the washing temperature, the number of washing bath tanks (the number of steps) and other various conditions. The relationship between the amount of water and the number of the washing tanks in the multistage countercurrent system can be determined by the method described in Journal of the Society of Motion Picture and Television Engineers, 64, 248-253 (May, 1955). Usually, the number of steps in the multistage countercurrent system is preferably from 3 to 15, and particularly preferably from 3 to 10.

The pH of the washing or stabilizing stage is preferably from 4 to 10, and more preferably from 5 to 8. The temperature is generally from 20° C. to 50° C., and preferably from 25° C. to 45° C., although it can be variously established depending on the use and characteristics of the photographic material.

The development processing method according to the invention is carried out using an automatic processor. The automatic processor preferably used in the invention will be described below.

In the invention, the feeding linear speed of the automatic processor is preferably 5,000 mm/minute or more, and more preferably from 10 m/minute to 45 m/minute.

Drying conditions of the photographic material also have an effect on evaporation of the processing solution. As the drying system, the use of a ceramic hot air heater is preferred, and the supplied air flow is preferably from 4 m³ to 40 m³ per minute, and particularly preferably from 10 m³ to 30 m³ per minute.

Then, the photographic materials to which the invention is applied will be described below.

The photographic material of the invention is a silver halide photographic material comprising a support having provided thereon at least one blue-sensitive layer, green-sensitive layer and red-sensitive layer, respectively.

In the multi-layer silver halide color photographic material, the light-sensitive layer is a unit light-sensitive layer having color sensitivity to any one of blue light, green light and red light. Layers constituting the unit light-sensitive layer are generally arranged in order of the red-sensitive layer, the green-sensitive layer and the blue-sensitive layer from the side of the support. However, depending on the purpose, they may be arranged contrary to the above-mentioned order, or may be arranged so as to place a different light-sensitive layer between the layers having the same color sensitivity. A light-insensitive layer may be placed between the above-mentioned silver halide light-sensitive layers, as the most upper layer or as the lowest layer. These layers may contain couplers described later, DIR compounds, color-mixing inhibitors and the like. In a plurality of silver halide emulsion layers constituting each unit light-sensitive layer, two emulsion layers of high sensitivity and low sensitivity, are preferably arranged in order of lowering the degrees of sensitivity toward a support as described in DE 1,121,470 or GB 923,045.

Specifically, the light-sensitive layers can be arranged in the order of a low-sensitivity blue-sensitive layer (BL), a high-sensitivity blue-sensitive layer (BH), a high-sensitivity green-sensitive layer (GH), a low-sensitivity green-sensitive layer (GL), a high-sensitivity red-sensitive layer (RH) and a low-sensitivity red-sensitive layer (RL), in the order of BH, BL, GL, GH, RH and RL, or in the order of BH, BL, GH, GL, RL and RH from the farthest side from a support.

The light-sensitive layers can also be arranged in the order of a blue-sensitive layer, GH, RH, GL and RL from the farthest side from a support as described in Japanese Patent Publication No. 34932/1980. Further, they can also be arranged in the order of a blue-sensitive layer, GL, RL, GH and RH from the farthest side from a support as described in Japanese Patent Laid-Open Nos. 25738/1981 and 63936/1987.

A preferred silver halide used in the material for photographing is silver iodobromide, silver iodochloride or silver iodochlorobromide containing about 30 mol % or less of silver iodide. Particularly preferred is silver iodobromide or silver iodochlorobromide containing about 0.5 mol % to about 10 mol % of silver iodide.

Silver halide particles contained in the photographic emulsion may be in a regular crystal form such as a cubic, octahedral or tetradecahedral form, an irregular crystal form such as a spherical or tabular form, a form having a crystal defect such as a twin plane, or a combined form thereof. Further, they may have a so-called core/shell structure comprising a core portion and a shell portion surrounding the core portion.

As for the particle size of the silver halide, particles suitable for each light-sensitive layer are prepared, so that ones having a wide range of particle sizes are used. They may be either finely divided particles having a diameter of a projected area of 0.05 to 0.2 μm, or large-sized particles having a diameter of a projected area of 1.0 to 5 μm. Further, they maybe either a polydisperse emulsion or a monodisperse emulsion. However, it is preferred that the mode value of size distribution of particles contained in the highest sensitivity unit layer of at least one layer of the red-sensitive layer, the green-sensitive layer and the blue-sensitive layer is 0.3 μm or less, and that the silver halide particles of the unit layer are silver iodobromide particles having a Br content of 50 mol % or more. More preferably, the mode value of size distribution of particles contained in each highest sensitivity unit layer of the red-sensitive layer, the green-sensitive layer and the blue-sensitive layer is 0.3 μm or less. The mode value of size distribution thereof is preferably 0.1 μm or more.

The amount of silver applied onto the photographic material used in the invention is preferably from 1.0 to 8.5 g/m², and more preferably from 2.0 to 6.0 g/m².

In the color photographic material used in the invention, the total film thickness of all hydrophilic colloidal layers on the side having the emulsion layer is preferably 28 μm or less, more preferably 25 μm or less, still more preferably 22 μm or less, and particularly preferably 20 μm or less. The film swelling speed T_{½} is preferably 30 seconds or less, and more preferably 20 seconds or less. T_{½} is defined as a time required to reach ½ of a saturated film thickness, taking 90% of a maximum thickness of a swelled film reached by processing with a color developing solution at 30° C. for 3 minutes and 15 seconds as the saturated film thickness. The film thickness means a thickness measured after the photographic material is kept for 2 days under conditions of 25° C. and 55% (RH), and T_{½} can be measured by using a swellometer described in A. Green et al., Photogr. Sci. Eng. Vol. 19, No. 2, pages 124 to 129. T_{½} can be adjusted by adding a hardening agent to gelatin as a binder, or by changing the above-described aging conditions after coating. The swelling rate is preferably 150% to 400%. The swelling rate can be calculated according to the equation: (maximum swelled film thickness−film thickness)/film thickness, from the maximum swelled film thickness under the above-described conditions.

The silver halide photographic emulsions which can be used in the invention can be prepared, for example, according to methods described in Research Disclosure (hereinafter abbreviated as “RD”), No. 17643, pages 22 and 23, “I. Emulsion Preparation and Types” (December, 1978), ibid., No. 18716, page 648 (November, 1979), ibid., No. 307105, pages 863 to 865 (November, 1979), P. Glafkides, “Chemie et Phisique Photographique” (Paul Montel, 1967), G. F. Duffin, “Photographic Emulsion Chemistry” (Focal Press, 1966) and V. L. Zelikman et al., “Making and Coating Photographic Emulsion” (Focal Press, 1964). Monodisperse emulsions described in U.S. Pat. Nos. 3,574,628 and 3,655,394 and GB 1,413,748 are also preferably used.

Further, tabular particles having an aspect ratio of about 3 or more can also be used in the invention. The tabular particles can be readily prepared according to methods described in Gutoff, “Photographic Science and Engineering”, Vol. 14, pages 248 to 257 (1970), U.S. Pat. Nos. 4,434,226, 4,414,310, 4,433,048 and 4,439,520, and GB 2,112,157.

The silver halide emulsions subjected to physical ripening, chemical ripening and spectral sensitization are usually employed. Additives used in such stages are described in RD, No. 17643, ibid., No. 18716 and ibid., No. 307105, and corresponding portions thereof are summarized in the following table.

In the color photographic material used in the invention, two or more kinds of emulsions which are different in at least one characteristic of the particle size, particle size distribution, halogen composition, particle shape and sensitivity of the light-sensitive silver halide emulsion can be mixed to use them in the same layer.

Photographic additives which can be used in the invention are also described in RDs, and portions described relating thereto are shown in the following table:

| Kind of Additive | | RD 17643 | RD 18716 | RD 307105 |
|---|---|---|---|---|
| 1. | Chemical | page 23 | page 648, right | page 866 |
| | Sensitizers | | column | |
| 2. | Sensitivity | | page 648, right | |
| | Accelerators | | column | |
| 3. | Color Sensiti- | pages 23- | page 648, right | pages 866- |
| | zers, | 24 | column to page | 868 |
| | Supersensitizers | | 649, right column | |
| 4. | Brighteners | page 24 | page 647, right | page 868 |
| | | | column | |
| 5. | Light Absorbers, | pages 25- | page 649, right | page 873 |
| | Filter Dyes, | 26 | column to page | |
| | Ultraviolet Ab- | | 650, left column | |
| | sorbers | | | |
| 6. | Binders | page 26 | page 651, left | pages 873- |
| | | | column | 874 |
| 7. | Plasticizers, | page 27 | page 650, right | page 876 |
| | Lubricants | | column | |
| 8. | Coating Aids, | pages 26- | page 650, right | pages 875- |
| | Surfactants | 27 | column | 876 |
| 9. | Antistatic | page 27 | page 650, right | pages 876- |
| | Agents | | column | 877 |
| 10. | Matting Agents | | | pages 878- |
| | | | | 879 |

Various dye-forming couplers can be used in the color photographic materials. However, the following couplers are particularly preferred.

Yellow Couplers: couplers represented by formulas (I) and (II) of EP-A-502,424; couplers represented by formulas (1) and (2) of EP-A-513,496 (particularly, Y-28 found on page 18); couplers represented by formula (I) described in claim 1 of EP-A-568, 037; couplers represented by general formula (I) found on lines 45 to 55 of column 1 of U.S. Pat. No. 5,066,576; couplers represented by general formula (I) described in paragraph 0008 of Japanese Patent Laid-Open No. 274425/1992; couplers described in claim 1 on page 40 of EP-A-498,381 (particularly, D-35 found on page 18); couplers represented by formula (Y) found on page 4 of EP-A-447,969 (particularly, Y-1 (page 17) and Y-54 (page 41)); and couplers represented by formulas (II) to (IV) found on lines 36 to 58 of column 7 of U.S. Pat. No. 4,476,219 (particularly, II-17and II-19 (column 17), and II-24 (column 19)).

Magenta Couplers: L-57 (page 11, lower right column), L-68 (page 12, lower right column) and L-77 (page 13, lower right column) of Japanese Patent Laid-Open No. 39737/1991; A-4-63 (page 134), and A-4-73 and A-4-75 (page 139) of European Patent 456,257; M-4 and M-6 (page 26), and M-7 (page 27) of European Patent 486,965; M-45 (page 19) of EP-A-571,959; M-1 (page 6) of Japanese Patent Laid-Open No.204106/1993; and M-22 described in paragraph 0237 of Japanese Patent Laid-Open No. 362631/1992.

Cyan Couplers: CX-1, CX-3, CX-4, CX-5, CX-11, CX-12, CX-14 and CX-15 (pages 14 to 16) of Japanese Patent Laid-Open No. 204843/1992; C-7 and C-10 (page 35), C-34 and C-35 (page 37), (I-1) and (I-17) (pages 42 to 43) of Japanese Patent Laid-Open No. 43345/1992; and couplers represented by general formulas (Ia) and (Ib) described in claim 1 of Japanese Patent Laid-Open No. 67385/1994.

Polymer Couplers: P-1 and P-5 (page 11) of Japanese Patent Laid-Open No. 44345/1990.

As couplers which produce color forming dyes having appropriate diffusibility, ones described in U.S. Pat. No. 4,366,237,GB2,125,570,European Patent 96,570and DE 3,234,533 are preferred.

Couplers for correcting unnecessary absorption of color forming dyes are preferably yellow-colored cyan couplers represented by formulas (CI), (CII), (CIII) and (CIV) described on page 5 of EP-A-456,257 (particularly, YC-86 found on page 84); yellow-colored magenta couplers ExM-7 (page 202), Ex-1 (page 249) and Ex-7 (page 251) described in EP-A-456,257 described above; magenta-colored cyan coupler CC-9 (column 8) and CC-13 (column 10) described in U.S. Pat. No. 4,833,069; and colorless masking couplers represented by (2) (column 8) of U.S. Pat. No. 4,387,136 and formula (A) described in claim 1 of WO92/11575 (particularly, compounds exemplified on pages 36 to 45).

As additives other than couplers, there can be added known dispersion mediums for oil-soluble organic compounds, impregnating lattices for oil-soluble organic compounds, scavengers for oxides of developing agents, stain inhibitors, fading inhibitors, hardeners, precursors of development inhibitors, stabilizers, antifoggants, chemical sensitizers, dyes, fine crystal dispersions of dyes, and ultraviolet absorbers.

Supports suitable for the color photosensitive material used in the method of the present invention, are described in RD (above-mentioned) No. 17643, page 28, ibid., No. 18716, page 647, right column to page 648, left column, and ibid., No.307105, page 879.

As the support, a cellulose triacetate support and a polyester support are preferably used in the present invention, and the detailed explanation thereof is described in Journal of Technical Disclosure No. 94-6023 (Japan Institute of Invention and Innovation; 3/15, 1994).

The color photographic material used in the invention is preferably provided with a hydrophilic colloidal layer (referred to as a back layer) having a total dry thickness of 2 to 20 μm on the side opposite to a side having an emulsion layer. It is preferred that the back layer contains the above-described light absorber, filter dye, ultraviolet absorber, antistatic agent, hardener, binder, plasticizer, lubricant, coating aid and surfactant. The swelling rate of the back layer is preferably 150% to 500%.

The image formation method of the invention is utilized particularly for image formation on the movie intermediate film. It is therefore necessary that the back face conductivity before development processing is sufficient in order to ensure the handling suitability of a long roll film, particularly the feeding properties of a film in exposure to laser spot light. The surface resistance value is desirably 1.0×10¹¹ Ω/square or less. The lower resistance results in the stabler feeding properties, so that it is not necessary to particularly specify the lower limit thereof.

Further, an antistatic agent is preferably used in the photographic material used in the invention. The antistatic agents include a carboxylic acid and a carboxylate, a sulfonate-containing polymer, a cationic polymer and an ionic surfactant compound.

Most preferred as the antistatic agent is fine particles of at least one crystalline metal oxide selected from zinc oxide, silicon dioxide, titanium dioxide, alumina, indium oxide, magnesium oxide, barium oxide, manganese oxide and vanadium oxide, which has a volume resistivity of 10⁷ Ω·cm or less, preferably 10⁵ Ω·cm or less, and a particle size of 0.001 to 1.0 μm, or fine particles of a double oxide thereof (Sb, P, B, In, S, Si, C, etc.), and further, fine particles of a sol-like metal oxide or a double oxide thereof. The content thereof in the photographic material is preferably from 5 to 500 mg/m², and particularly preferably from 10 to 350 mg/m². The amount ratio of the conductive crystalline oxide or the double oxide thereof to a binder is preferably from 1/300 to 100/1, and more preferably from 1/100 to 100/5.

It is preferred that the color photographic material has slipperiness. Lubricant-containing layers are preferably used on both of a light-sensitive layer face and a back face. The slipperiness is preferably from 0.01 to 0.25 in the coefficient of dynamic friction. The measurement at this time indicates a value at the time when transferred at 60 cm/minute with respect to a stainless ball having a diameter of 5 mm (25° C., 60% RH). In this evaluation, the replacement of the object material to the light-sensitive face also results in an approximately similar level of a value.

As the lubricants available in the invention, there can be used polyorganosiloxanes, higher fatty acid amides, metal salts of higher fatty acids, and esters of higher fatty acids and higher alcohols. They are preferably added to an outer most layer or a back layer of the emulsion layers. In particular, polydimethylsiloxane and a long-chain alkyl group-containing ester are preferred.

Then, as a beam light scan exposure apparatus for outputting the digital image formation used in the image formation method of the invention on the silver salt color film, there can be used a known scanning type exposure apparatus. As irradiation light of beam light, there is used laser light or a cathode ray.

A cathode ray tube exposure apparatus is simple, compact and low in cost, compared to an apparatus using a laser. However, as a general-purpose apparatus in this industry for processing a large number of movie films, a scan exposure apparatus using laser light is more preferred.

As a laser light source of the scan exposure apparatus, there is preferably used a digital scan exposure system using monochromatic high-density light such as a gas laser, a light emitting diode, a semiconductor laser or a second harmonic generation light source (SHG) in which a non-linear optical crystal is combined with a solid laser using a semiconductor laser as an excitation light source. In order to make the system compact and low in cost, the semiconductor laser or the second harmonic generation light source (SHG) in which the non-linear optical crystal is combined with the semiconductor laser or the solid laser is preferably used. In particular, in order to design the apparatus compact in size, low in cost, long in life and high instability, the semiconductor laser is preferably used, and it is preferred that at least one of the exposure light sources is the semiconductor laser.

When such a scan exposure light source is used, the spectral sensitivity maximum wavelength of the photographic material used in the invention can be arbitrarily established depending on the wavelength of the light source for scan exposure. In the solid laser in which the semiconductor laser is used as the excitation light source, or in the SHG light source obtained by combining the semiconductor laser with the non-linear optical crystal, the oscillation wavelength of the laser can be reduced to half, so that blue light and green light can be obtained. It is therefore possible to allow the three usual wavelength regions of blue, green and red to have the spectral sensitivity maximum of the photographic material.

The exposure time in such scan exposure is preferably 10⁻⁴ second or less, and more preferably 10⁻⁶ second or less, defining it as the time exposing the pixel size at the time when the pixel density is 400 dpi. Further, although the lower limit of the exposure time is determined depending on the laser oscillation apparatus, it is about 10⁻⁸ second.

### EXAMPLES

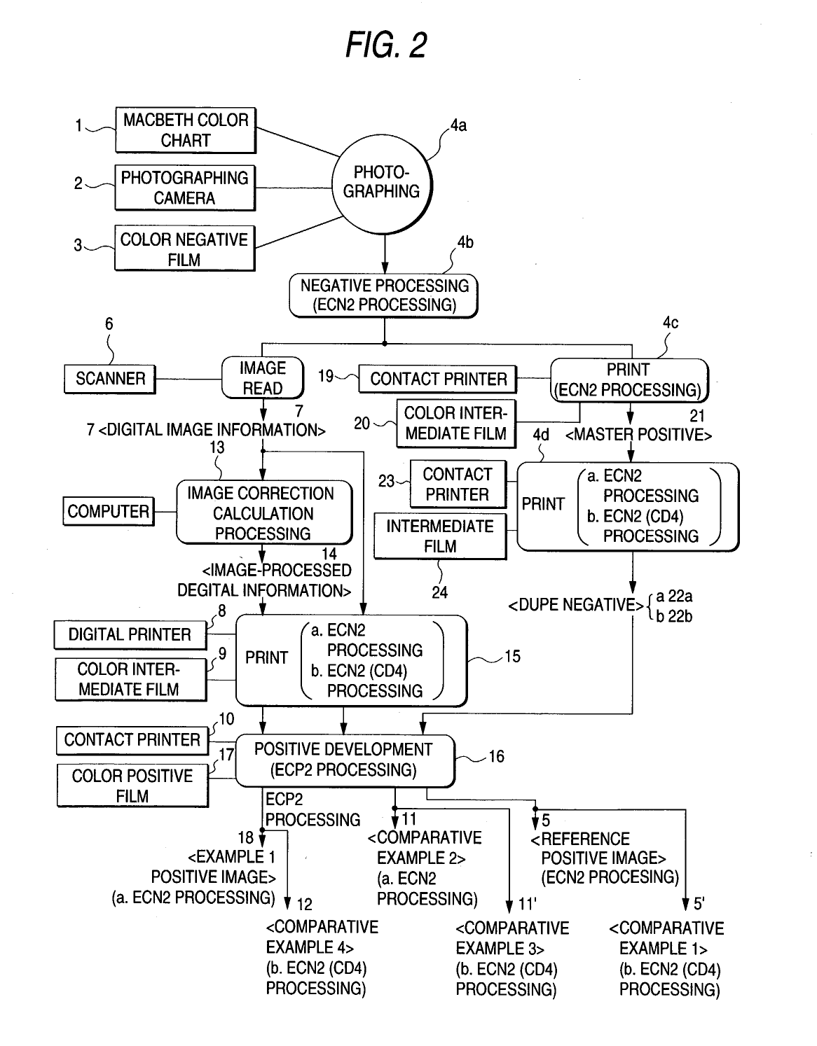

Specific examples of the invention will be illustrated below, but the invention is not limited thereto. Further, FIG. 2 is a flow diagram collectively showing embodiments of image formation processes of the example and comparative examples. The number attached to each element in the figure agrees with the numeral number indicated in parentheses in the following description. Furthermore, a process is described in a round frame in the figure, and a material or equipment used in the process is described in a square frame. In addition, the state of an image in the process is described in< >.

### REFERENCE PROCESSING (CONVENTIONAL SYSTEM)

Tungsten irradiation was conducted to a Macbeth color chart (1), and photographs were taken (24 frames/second) with an ARRI BL3 movie camera (manufactured by ARNOLD & RICHTER) (2) (4a). For photographing, a commercial movie film (FUJI COLOR NEGATIVE FILM Type 8552, manufactured by Fuji Photo Film Co., Ltd.) (3) was used. This exposed film was subjected to movie negative processing (ECN-2 processing) (4b), and printing was made (development processing was ECN-2 processing) (4c) on a color intermediate film (FUJI COLOR INTERMEDIATE FILM Type 8502, manufactured by Fuji Photo Film Co., Ltd.) (20) with a contact printer (Model C Printer, manufactured by BELL & HOWELL) (19) to prepare a master positive (21).

Using this master positive, printing was made (development processing was ECN-2 processing) (4d) on a color intermediate film (FUJI COLOR INTERMEDIATE FILM Type 8502, manufactured by Fuji Photo Film Co., Ltd.) (24) with a contact printer (Model C Printer, manufactured by BELL & HOWELL) (23) to prepare dupe negative (22a).

Using this dupe negative (22a), printing was made (development processing was ECP-2 processing, prints on positive films were hereinafter all developed by ECP-2 processing) (16) on a color intermediate film (FUJI COLOR POSITIVE FILM Type 3519, manufactured by Fuji Photo Film Co., Ltd.) (17). This mage formation process was a conventional standard positive image formation process, and the resulting image was taken as a reference positive image (5).

### Comparative Example 1

The master positive (21) was prepared in the same manner as with the above-mentioned process. Using this master positive, printing was made (in the development processing, Kodak CD-3, the developing agent of the ECP-2 processing, was changed to equimolar CD-4) on the color intermediate film (FUJI COLOR INTERMEDIATE FILM Type 8502, manufactured by Fuji Photo Film Co., Ltd.) (24) with the contact printer (Model C Printer, manufactured by BELL & HOWELL) (23) to prepare dupe negative (22b). Using this dupe negative (22b), printing was made (ECP-2 processing) on the color intermediate film (FUJI COLOR POSITIVE FILM Type 3519, manufactured by Fuji Photo Film Co., Ltd. ) (17) to prepare a positive image (5′) of Comparative Example 1.

### Comparative Example 2

The above-mentioned exposed film of (3) was subjected to movie negative processing (ECN-2 processing) (4b), and the data was converted from the processed negative to digital image data (7) with a color scanner (IMAGICA IMAGER, manufactured by IMAGCA) (6). The data was printed on a color intermediate film (FUJI COLOR POSITIVE FILM Type 8502, manufactured by Fuji Photo Film Co., Ltd.) (9) with a digital film recorder (ARRILASER, manufactured by ARNOLD & RICHTER) (8), and subjected to ECN-2 processing (15). The printing with the ARRILASER was made by the scan exposure system using converged light having a beam spot diameter of 12 μm and a resolution of 2 K, at a pixel density of 2048×2048 pixels/frame and at a scan speed of 5 seconds/frame. Further, the mode values of size distribution of particles contained in the respective unit layers of the three light-sensitive layers of the above-mentioned color intermediate film were 0.29, 0.20, 0.14, 0.20, 0.15, 0.10, 0.24, 0.15 and 0.09, in the order of o, m and u layers of the blue-sensitive layer, o, m and u layers of the green-sensitive layer and o, m and u layers of the red-sensitive layer. The o, m and u layers used herein each means a high sensitivity, intermediate sensitivity and low sensitivity layers.

The intermediate film obtained by printing the image and subjecting it to the ECN-2 processing was printed on the color intermediate film (FUJI COLOR POSITIVE FILM Type 3519, manufactured by Fuji Photo Film Co., Ltd.) (17) with a contact printer (Model C Printer, manufactured by BELL & HOWELL) (10). This was taken as a positive image (11) of Comparative Example 2.

### Comparative Example 3

The same operations as with the above-mentioned reference positive image formation process were conducted for all such as the movie film for photographing (3), conversion to the digital image data (7) using the color scanner (IMAGICA IMAGER, manufactured by IMAGCA) (6), printing on the color intermediate film (FUJI COLOR POSITIVE FILM Type 8502, manufactured by Fuji Photo Film Co., Ltd.) (9) with the digital film recorder (ARRILASER, manufactured by ARNOLD & RICHTER) (8), and printing on the color intermediate film (FUJI COLOR POSITIVE FILM Type 3519, manufactured by Fuji Photo Film Co., Ltd.) (17) with the contact printer (Model C Printer, manufactured by BELL & HOWELL) (10), with the exception that Kodak CD-3, the developing agent of the ECP-2 processing (15), was changed to equimolar CD-4. Thus, a positive image (11′) of Comparative Example 3 was obtained.

### Example 1

The digital image data (7) obtained by the same process as with Comparative Examples 2 and 3 described above was subjected to image correction calculation processing (13) in which the above-mentioned 3×3 matrix data processing was combined with the SCC data processing.

Using image-corrected digital image data (14) thus obtained, the data was printed on the color intermediate film (FUJI COLOR POSITIVE FILM Type 8502, manufactured by Fuji Photo Film Co., Ltd.) (9) with the digital film recorder (ARRILASER, manufactured by ARNOLD & RICHTER) (8), and subjected to the ECN-2 processing (15). This image was printed on the color intermediate film (FUJI COLOR POSITIVE FILM Type 3519, manufactured by Fuji Photo Film Co., Ltd.) (17) with the contact printer (Model C Printer, manufactured by BELL & HOWELL) (10) to prepare a positive image (18) of Example 1.

### Comparative Example 4

Processing was conducted in the same manner as with Example 1 with the exception that Kodak CD-3, the developing agent of the ECP-2 processing (15) after printing on the intermediate film (9), was changed to equimolar CD-4. Then, printing was made on the color intermediate film (FUJI COLOR POSITIVE FILM Type 3519, manufactured by Fuji Photo Film Co., Ltd.) (17) with the contact printer (Model C Printer, manufactured by BELL & HOWELL) (10) to prepare a positive image of Comparative Example 4.

Evaluation

Positive films on which Macbeth color chart images of Example 1 and Comparative Examples 1 to 4 were printed were each projected together with a positive film of the reference positive image, and the chroma saturation and the conciseness of the images were evaluated by “good”, “fair” and “poor” (wherein “good”: identical to the reference positive image, “fair”: slightly poorer than the reference positive image, but within the allowable range, and “poor”: clearly poorer than the reference positive image). Results thereof are shown in Table 1.

TABLE 1

| Dupe Negative | Positive Image | Image | |
|---|---|---|---|
| Processing | Formation | Quality | Note |
| a ECN-2 process- | Usual face exposure | Good | Reference |
| ing | duplication print | | Image |
| | image | | |
| b ECN-2 (CD-4) | Usual face exposure | Good | Comparative |
| processing | duplication print | | Example 1 |
| | image | | |
| a ECN-2 process- | Digital printer·print | Poor | Comparative |
| ing | image | | Example 2 |
| b ECN-2 (CD-4) | Digital printer·print | Fair to | Comparative |
| processing | image | good | Example 3 |
| a ECN-2 process- | Digital printer·print· | Good | Example 1 |
| ing | image processing | | |
| b ECN-2 (CD-4) | Digital printer·print· | Good | Comparative |
| processing | image processing | | Example 4 |

These results reveal that the positive film (18) (Example 1) obtained by digital film recording on the intermediate film and the movie ECN processing according to the invention is identical in chroma saturation and conciseness to the color positive film (reference positive image) (5) obtained by the face exposure dupe process using the ordinary intermediate film, resulting in an equivalent color reproduction region to prepare the color positive film without deterioration of the color reproduction region. At the same time, the results show that the invention provides a color reproduction region equivalent to the reference image without changing the ECN-2 processing widely popularized as movie laboratory processing.

According to the method of the invention comprising applying chroma saturation changing processing to the digital image information in recording the digital image information on the silver salt color film by scan exposure and developing this with the CD-3-containing developing solution, the chroma saturation is not reduced, and as a result, it becomes possible to obtain the image having the same chroma saturation and conciseness as the color positive film obtained by the face exposure dupe process using the ordinary intermediate film.

The entire disclosure of each and every foreign patent application from which the benefit of foreign priority has been claimed in the present application is incorporated herein by reference, as if fully set forth.

What is claimed is:

1. An image formation method of recording digital image information on a silver salt color film to obtain an image,
the image formation method comprising:
applying chroma saturation changing processing to the digital image information;
recording the image information to which the processing has been applied, on the silver salt color film by a scan exposure; and
developing the exposed color film with a CD-3-containing developer to obtain the image.

2. The image formation method according to claim 1, wherein the chroma saturation changing processing includes at least one processing of matrix processing, SCC processing and 3DLUT changing processing.

3. The image formation method according to claim 1, wherein the chroma saturation changing processing is combined processing of matrix processing and SCC processing.

4. The image formation method according to claim 1, wherein the chroma saturation changing processing is combined processing of matrix processing, SCC processing and 3DLUT changing processing.

5. The image formation method according to claim 1, wherein the silver salt color film includes a red-sensitive layer, a green-sensitive layer and a blue-sensitive layer, and a mode value of a particle size distribution of silver halide particles in a highest sensitivity unit layer of at least one of a red-sensitive layer, a green-sensitive layer and a blue-sensitive layer is 0.3 μm or less, and the silver halide particles include a silver halide containing 50 mol % or more of AgBr.

6. The image formation method according to claim 1, wherein the silver salt color film includes a tubular silver halide particle in an amount of 50 wt % or more, based on total weight of silver halide particles.

7. The image formation method according to claim 1, wherein the back surface of the silver salt color film before development processing has the conductivity of 1.0×10¹¹ Ω/square or less as a surface resistance value.

8. The image formation method according to claim 1, wherein the digital image information is obtained by scanning a movie color negative film developed.

9. The image formation method according to claim 1, wherein the digital image information is obtained with a digital video camera.

10. The image formation method according to claim 1, wherein the exposure intensity of the scan exposure is variable, and the exposure time is 10⁻⁴ second per pixel or less.
